(19) United States
(12) Patent Application Publication
(10) Pub. No.: US 2018/0104571 A1
(43) Pub. Date: Apr. 19, 2018

(54) BOARD GAME APPARATUS

(71) Applicant: Alvin Cornell Hopkins, Townsend, DE (US)

(72) Inventor: Alvin Cornell Hopkins, Townsend, DE (US)

(21) Appl. No.: 15/293,450

(22) Filed: Oct. 14, 2016

(51) Int. Cl. A63F 3/00; A63F 11/00; A63F 13/822

(52) U.S. Cl. CPC A63F 3/00006; A63F 2300/807; A63F 13/822; A63F 11/0011

(57) ABSTRACT

A board game apparatus for use by a plurality of opposing players traversing opposite directions along a game board is provided. The game board provides a plurality of marked spaces constituting a path extending between two opposing starting lines, each marked space of the plurality of marked spaces provide a plurality of game indicia including two numeral indices, wherein the two numeral indicia represent the number of marked spaces until the two opposing starting lines, respectively. Each player represented by a token indicating their offensive position along the path. The board game apparatus includes pair of playing-dice for indicating the number of marked spaces along the path, and a pair of s-dice for indicating the number of marked spaces along the path the offensive player moves before the defensive player moves in an opposite direction along said path.

### BACKGROUND OF THE INVENTION

The present invention relates to strategic games and, more particularly, to a board game apparatus for use by a plurality of opposing players traversing opposite directions along a game board.

### SUMMARY OF THE INVENTION

In one aspect of the present invention, a board game apparatus for use by a plurality of opposing players traversing opposite directions along a game board includes a game board providing a plurality of marked spaces constituting a path extending about the game board between two opposing starting lines, each marked space of the plurality of marked spaces provide a plurality of game indicia, wherein the plurality of game indicia includes two numeral indices, wherein the two numeral indicia represent the number of marked spaces until the two opposing starting lines, respectively; the plurality of opposing players comprises an offensive and defensive player; a token associated with each offensive and defensive player of the plurality of opposing players, wherein the token associated with the offensive player represents a current position along the path, and wherein the token associated with the defensive player represents a place position offset from said current position; a pair of playing-dice for indicating the number of marked spaces along the path the offensive player moves before they move again, unless if the offensive player does not reach either said place position or the opposing starting line in two consecutive rolls of the pair of playing-dice, then the defensive player moves in an opposite direction along said path; and a pair of s-dice for indicating the number of marked spaces along the path the offensive player moves before the defensive player moves in an opposite direction along said path.

In another aspect of the present invention, the board game apparatus for use by a plurality of opposing players traversing opposite directions along a game board includes a game board providing a plurality of marked spaces constituting a path extending about the game board between two opposing starting lines, each marked space of the plurality of marked spaces provide a plurality of game indicia, wherein the plurality of game indicia includes: two numeral indices, wherein the two numeral indicia represent the number of marked spaces until the two opposing starting lines, respectively; and ten color-coded indicia; the plurality of opposing players comprises an offensive and defensive player; a token associated with each offensive and defensive player of the plurality of opposing players, wherein the token associated with the offensive player represents a current position along the path, and wherein the token associated with the defensive player represents a place position offset from said current position, wherein the place position is always offset between one and ten marked spaces from the current position; a pair of playing-dice for indicating the number of marked spaces along the path the offensive player moves before they move again, unless if the offensive player does not reach either said place position or the opposing starting line in two consecutive rolls of the pair of playing-dice, then the defensive player moves in an opposite direction along said path, wherein the pair of playing-dice total between one and twelve marked spaces per roll; a pair of s-dice for indicating the number of marked spaces along the path the offensive player moves before the defensive player moves in an opposite direction along said path, wherein the pair of s-dice total between five and fifty-five marked spaces per roll; and a plurality of color-coded cards for preventing use of marked spaces having a color-coded indicia matching a color of a played color-coded card of the plurality of color-coded cards.

These and other features, aspects and advantages of the present invention will become better understood with reference to the following drawings, description and claims.

### BRIEF DESCRIPTION OF THE DRAWINGS

FIG. 1 is a top plan view of an exemplary embodiment of a game board of the present invention; and

FIG. 2 is a top plan view of an exemplary embodiment of a plurality of accessories of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, a board game apparatus for use by a plurality of opposing players traversing opposite directions along a game board is provided. The game board provides a plurality of marked spaces constituting a path extending between two opposing starting lines, each marked space of the plurality of marked spaces provide a plurality of game indicia including two numeral indices, wherein the two numeral indicia represent the number of marked spaces until the two opposing starting lines, respectively. Each player represented by a token indicating their offensive position along the path. The board game apparatus includes pair of playing-dice for indicating the number of marked spaces along the path, and a pair of s-dice for indicating the number of marked spaces along the path the offensive player moves before the defensive player moves in an opposite direction along said path.

The present invention may include at least one computer with a user interface. The computer may include at least one processing unit coupled to a form of memory including. Each computer may include but not limited to, a desktop, laptop, or smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

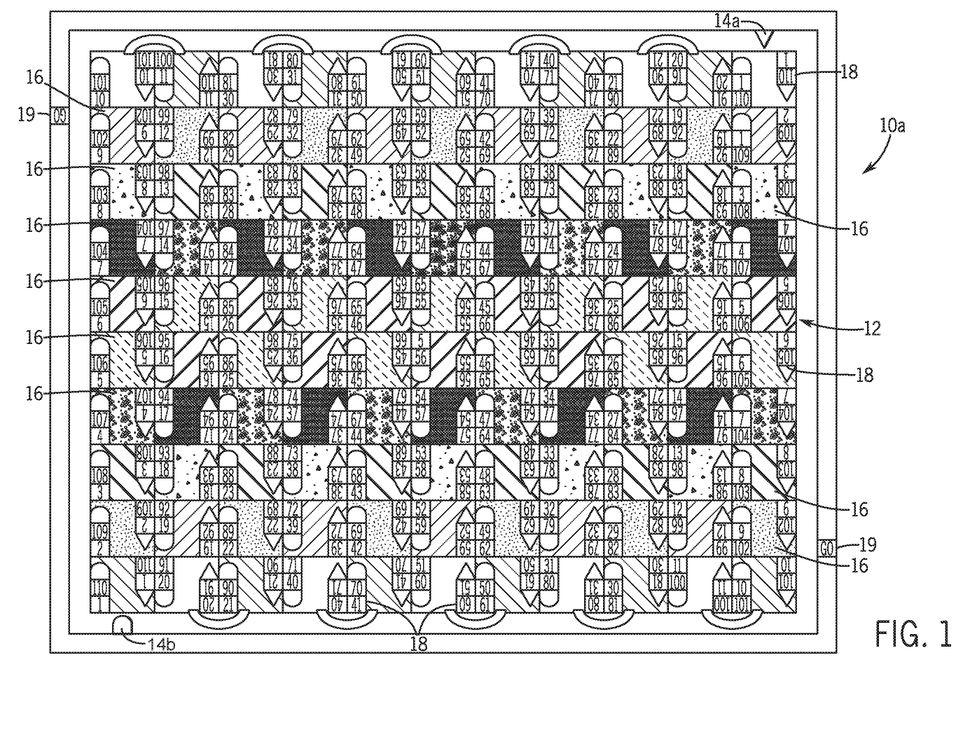

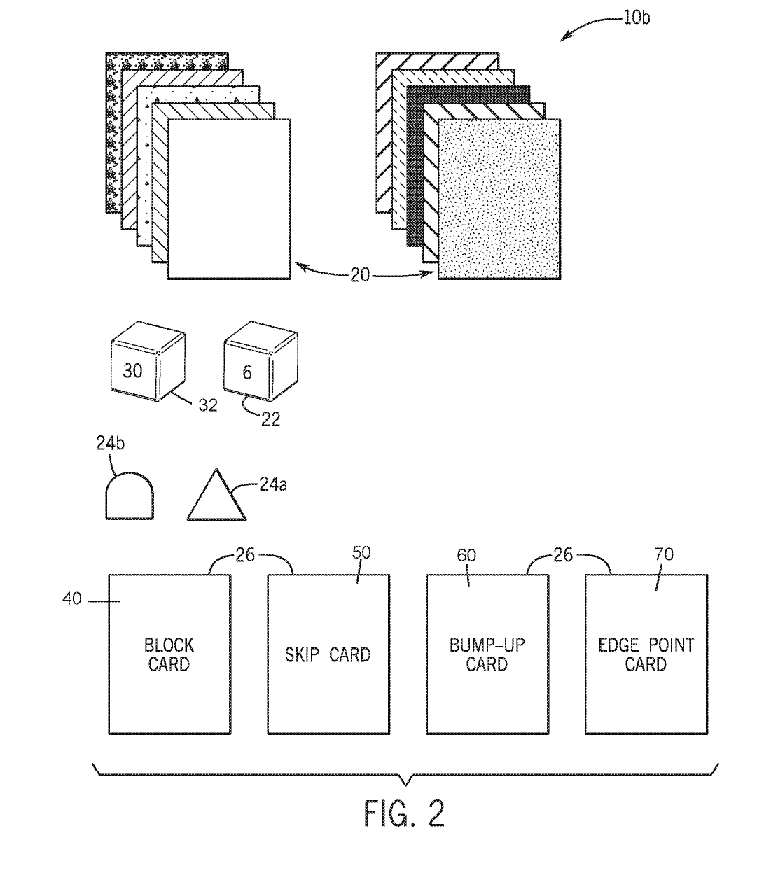

Referring to FIGS. 1 and 2, the present invention may include a board game 10 called “Back N Forth” providing a game board 10a and a plurality of accessories 10. The board game 10 may be played at two levels. Level 1 may be recommended for ages 9-12 and level 2 for ages 13-adult. The following refers to level 1 unless specified as level 2.

The playing surface 12 may provide a plurality of color-coded boxes 16 organized in rows and columns. The color-coded may form a repeating pattern for making it easy to count color-coded boxes 16 when advancing there along; for example, the 10th color-coded box 16 may be the same color so a user can count by ten and so skip to the same color color-coded boxes 16.

In each color-coded box 16 may provide a first and second numerical indicia 18, as illustrated in FIG. 1 (in certain embodiments, the two first and second numerical indicia 18 are duplicated within each color-coded box 16 so as to be presented in two opposing orientations addressing opponents sitting facing the game board 10a facing each other). The first or top numerical indicia 18 (the ‘top’ being understood to be the uppermost numerical indicia 18 of the two numerical indicia 18 relative to a readable orientation when facing the game board 10a) represents the number of boxes player A needs to advance (from that respective box) in order to pass the opponent's (player B) start line, scoring either edge points (5 points) or post points (10 points). The second (or bottom) numerical indicia 18 represents the number of boxes the opponent (player B) needs in order to pass player A's start line to score a post or edge points.

Accordingly, the game board 10a provides the starting line adjacent to a starting point 14a and 14b. Initiation of player movement begins at the starting line/starting point and progresses up the adjacent column, to the top thereof at which the movement transfers to the adjacent column to the right by moving one row over to the right. Game play can also include a player taking over at a color-coded box 16 where the other (offensive) player's play stopped. Upon taking over on offense, heads towards his opponent's start line, moving up and down the of color-coded box 16 in the zig-zag manner described above.

The disposition and movement of each player is represented by two player tokens, a first token 24a and a second token 24b representing player A and player B, respectively. As a marker, the token may be used by a player on offense to move forward along the grid of color-coded boxes 16 based of the roll totals of the playing-dices 22 or s-dices 32. Also used by a player on defense may use the token to mark the color-coded box 16 where his opponent must advance to in order to place.

Besides tokens, the accessories may include color-coded cards 20, playing-dice 22, s-dice 32, and printed cards 26, as illustrated in FIG. 2. The play dice 22 are a set of two dice with one die numbered 1 through 6 and the other die numbered 2 through 6 with one side blank that equals 0. The s-dices 32 are a set of two dice with one die sides numbered 5, 10, 15, 20, 25 and 30. The other dice sides are numbered 5, 10, 15, 20, and 25 with one side blank that equals 0. A ‘roll total’ is the sum of the numbers on the two dice 22 or 32 after rolling, wherein the lank side equals zero. The roll total is the number of color-coded boxes 16 are traversed by the player's token.

The board game 10 may include a set up definitions. The set of definitions may include, but not be limited to the following:

‘Offense’/‘Defense’—when it's a player's turn to roll the dice 22 or 32 to advance the respective token, that player is considered to be on offense and the other player is on defense.

‘Post’—when a player advances their token past the opponent's starting line, this action is worth 10 points;

‘Place’—when a player advances 10 or more boxes using the roll totals of the playing-dices 22 after 1 or 2 rolls. This action enables the offensive player to continue on offense.

‘Edge Point’—when a player advances their token past the opponent's start line using the roll totals of the two s-dice 32. This action is worth 5 points.

‘Skip’—after the offensive player's first roll of the playing-dice 22, he can use this action by rolling the two s-dices 32 on his second roll to advance his token.

Note, the play dice 22 may be used only to attempt to place or post, while the s-dices 32 are used only to skip or attempt edge points.

The printed cards 26 may include block cards 40, skip cards 50, bump-up cards 60, edge point cards 70, and color-coded cards 20.

The skip card 50—when played indicates that the offensive player will skip the second roll of the playing-dices 22 and roll the s-dices 32 to advance the play-marker.

The edge point card 70—when played indicates the offensive player will roll the s-dices 32 attempting to get 5 ‘edge points.’

The block card 40 (level 2)—may be used by a player when on the defensive to limit his opponent to only one roll of the playing-dice 22. The card must be placed on the board before the offensive player's first roll. The player on offense must now place in only one roll or he can skip or try for an edge point. The offensive player cannot use a bump-up card 60 to counter.

The bump-up card 60 (level 2)—may be used by an offensive player when on to get an extra roll of the playing-dice 22. The bump-up card 60 must be placed on the board after his first roll. He now has two rolls (instead of one second roll) in order to place. He moves their token the number of boxes equal to the roll totals. If the roll totals are not enough to place, he cannot skip or try for an edge point and the defensive player takes over at that box. If the roll totals are enough to place, the offensive player continues with another turn to advance. The defensive player cannot use the block card 40 to counter.

The color card (level 2) 20—a card selected by each player that indicates the color-coded box 16, whereas if the offensive player (only on the first roll) lands on the color the defensive player selected, can no longer advance and must skip or try an edge point. There are ten color cards 20 matching each of the ten colored-coded boxes 16 on the play surface 12.

In level 2, a “go” indicia 19 may be provided along opposing sides of the playing surface 12, wherein the “go” indicia 19 is understood to enable the player on defense to tap with a finger giving the offensive player the okay to roll the dices 22 or 32. This gives the defensive player time to make decision on actions he can take before the offensive player rolls. This action is only required if both players agree to use it.

### Rules:

The present invention may include a set of rules, including but not limited to the following:

Determining offensive and defensive roles: players A and B sit facing each other and each player rolls one playing-dice 22. The player with the highest number gets the first turn to roll the playing-dice 22 playing offense starting from his start line. If each player rolls the same number, they must continue to roll one dice until one of them rolls a higher number.

Starting the game: in certain embodiments, at the start of the game each player may get one token 24a or 24b, one edge point card 70, one skip card 50, and for level 2, each player gets two block cards 40, four bumps up cards 60 and his choice of one color card 20.

After rolling the playing-dice 22, the offensive player moves their token forward the number of boxes 16 equal to the roll total counting each box as one. Each player must use their token to advance when on offense. When on defense each player must use his token to mark the box where the offensive player needs to advance to in order to place. This box will be 10 boxes away from where the offensive player takes his first roll. Each time the offensive player gets a place, the defensive player moves his play-marker to the next box where the offensive play must advance to in order to place, i.e., ten boxes away. This helps players keep track of positions on the board. In one roll of the playing-dice 22 or the s-dice 32, the total of the numbers on each dice is the number of boxes the player can advance.

The offensive player gets two rolls of the playing-dices 22 to achieve a place (advance 10 or more boxes). If the offensive player places on the first roll (roll total equal to or greater than 10) they moves their token the number of boxes 16 equal to the roll total, then gets another turn to try to place again in one or two rolls. If the offensive player fails to place on the first roll (roll total less than 10), he moves his token the number of boxes 16 equal to the roll total, then he must decide on taking his second roll, using the skip action card 50 or trying for an edge point. If the offensive player decides to take his second roll and fails to place, he moves his play-marker the number of boxes equal to the roll total and the defensive player takes over on offence at that box.

When a player decides to skip, he must let the defensive player know by saying this out loud or placing the skip card 50 on the board. The offensive player now rolls the s-dices 32 and advances his play-marker the number of boxes equal to the roll total. The defensive player now takes over on offense at that box.

When a player decides to attempt an edge point, he must let the defensive player know by saying this out loud or placing the edge point card 70 on the board. The offensive player now rolls the s-dices 32. If the roll total is greater than the top number in the numerical indicia 18 where he is attempting the edge point from, he gets 5 points. If the total is less than the top number he gets no points and the defensive player takes over on offense at that box where the edge point was attempted.

When a player advances his token past his opponent's start line using the playing-dices 22, he gets 10 points. After a player scores, the other player gets a turn to advance his play-marker starting from his start line. The first player to get 45 or more points wins the game.

### Strategy—Level 1

When on offense, you must continuously place using the roll of the playing-dices 22 until advancing pass your opponent's start line to post (10 points) or gets close enough to use the S-dices to try for an edge point (5 points). If you roll a low total on the first roll of the playing-dices 22 and you are close to your own start line, you must make a decision to skip or take the chance of getting a high enough number on the second roll to place. Being close to your start line and not getting a roll total high enough on your second roll to post, your opponent takes over at the box 16 you advanced to and may have an easy time scoring. So when you are close to your start line you may want to skip rather than attempt a second roll. This way one can advance their token further away making it more difficult for your opponent to score. However, if you take the risk of using your second roll you may place and now you can continue advancing on offense. If you are far behind your opponent in points, you may want to take more risk when on offense.

The lowest combination you can roll with the playing-dices 22 is 1 (blank+1) and the highest is 12. From these odds you make the decision to try a second roll of the playing-dices, skip or attempt an edge point.

The lowest combination you can roll with the s-dices 32 is 5 (blank+5) and the highest is 55 (30+25). From these odds you make the decision to skip or try for an edge point. So if you are within 55 boxes away from your opponent's start line (indicated by to top number in the box) you may want to try for an edge point, but if the roll total of the s-dices 32 does not total enough to pass the start line, your opponent takes over at the box 16 from where you attempted the edge point. So you may want to skip so you will at least push your opponent farther away from your start line.

### Strategy—Level 2

Same as Level 1, but has more actions a players can take to better his chances of scoring and make it more difficult for his opponent to score.

Each player can use his block cards 40 when on defense to make it harder for his opponent to advance. If a player is far behind in points, he can use this action to get more chances on offense. However, a player that is far ahead on points may use this action to make it harder for his opponent to catch up. Each player gets only two block cards 40 so they must use them wisely.

Each player can use his bump-up cards 60 to have a better chance of continuing on offense when the roll total on his first roll is low. This is a good action to use when a player is close to their start line and a skip may not push their opponent too far away. The chances are very high that he will post using the extra roll allowing him to continue on offense.

The color card 20 makes it more difficult for the player on offense to advance without the defensive player having to use his block card. In certain embodiments, there will be 11 boxes on the board that each player will own based on the color card 20 they select, so the chances are very good that the player on offense will land on one during his turn rolling the playing-dices 22.

It should be understood that the game board 10a and the accessories may be simulated on a computer. The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A board game apparatus for use by a plurality of opposing players traversing opposite directions along a game board, comprising:
a game board providing a plurality of marked spaces constituting a path extending about the game board between two opposing starting lines, each marked space of the plurality of marked spaces provide a plurality of game indicia, wherein the plurality of game indicia includes two numeral indices, wherein the two numeral indicia represent the number of marked spaces until the two opposing starting lines, respectively;
the plurality of opposing players comprises an offensive and defensive player;
a token associated with each offensive and defensive player of the plurality of opposing players, wherein the token associated with the offensive player represents a current position along the path, and wherein the token associated with the defensive player represents a place position offset from said current position;
a pair of playing-dice for indicating the number of marked spaces along the path the offensive player moves before they move again, unless if the offensive player does not reach either said place position or the opposing starting line in two consecutive rolls of the pair of playing-dice, then the defensive player moves in an opposite direction along said path; and
a pair of s-dice for indicating the number of marked spaces along the path the offensive player moves before the defensive player moves in an opposite direction along said path.

2. The board game apparatus of claim 1, wherein the place position is always offset between one and ten marked spaces from the current position.

3. The board game apparatus of claim 2, wherein the pair of playing-dice total between one and twelve marked spaces per roll.

4. The board game apparatus of claim 3, wherein the pair of s-dice total between five and fifty-five marked spaces per roll.

5. The board game apparatus of claim 1, wherein the plurality of game indicia then color-coded indicia.

6. The board game apparatus of claim 5, further comprising a plurality of color-coded cards for preventing use of marked spaces having a color-coded indicia matching a color of a played color-coded card of the plurality of color-coded cards.

7. A board game apparatus for use by a plurality of opposing players traversing opposite directions along a game board, comprising:
a game board providing a plurality of marked spaces constituting a path extending about the game board between two opposing starting lines, each marked space of the plurality of marked spaces provide a plurality of game indicia, wherein the plurality of game indicia includes:
two numeral indices, wherein the two numeral indicia represent the number of marked spaces until the two opposing starting lines, respectively; and
ten color-coded indicia;
the plurality of opposing players comprises an offensive and defensive player;
a token associated with each offensive and defensive player of the plurality of opposing players, wherein the token associated with the offensive player represents a current position along the path, and wherein the token associated with the defensive player represents a place position offset from said current position, wherein the place position is always offset between one and ten marked spaces from the current position;
a pair of playing-dice for indicating the number of marked spaces along the path the offensive player moves before they move again, unless if the offensive player does not reach either said place position or the opposing starting line in two consecutive rolls of the pair of playing-dice, then the defensive player moves in an opposite direction along said path, wherein the pair of playing-dice total between one and twelve marked spaces per roll;
a pair of s-dice for indicating the number of marked spaces along the path the offensive player moves before the defensive player moves in an opposite direction along said path, wherein the pair of s-dice total between five and fifty-five marked spaces per roll; and
a plurality of color-coded cards for preventing use of marked spaces having a color-coded indicia matching a color of a played color-coded card of the plurality of color-coded cards.

8. A computer-implemented method for a game for use by a plurality of opposing players traversing opposite directions along a game board, comprising:
providing an electronic representation of a game board providing a plurality of marked spaces constituting a path extending about the game board between two opposing starting lines, each marked space of the plurality of marked spaces provide a plurality of game indicia, wherein the plurality of game indicia includes two numeral indices, wherein the two numeral indicia represent the number of marked spaces until the two opposing starting lines, respectively, wherein the plurality of opposing players comprises an offensive and defensive player;
providing an electronic representation of a token associated with each offensive and defensive player of the plurality of opposing players, wherein the token associated with the offensive player represents a current position along the path, and wherein the token associated with the defensive player represents a place position offset from said current position;
providing an electronic representation of a pair of playing-dice for indicating the number of marked spaces along the path the offensive player moves before they move again, unless if the offensive player does not reach either said place position or the opposing starting line in two consecutive rolls of the pair of playing-dice, then the defensive player moves in an opposite direction along said path; and
providing an electronic representation of a pair of s-dice for indicating the number of marked spaces along the path the offensive player moves before the defensive player moves in an opposite direction along said path.
